(19) United States
(12) Patent Application Publication
(10) Pub. No.: US 2013/0151746 A1
(43) Pub. Date: Jun. 13, 2013

(54) ELECTRONIC DEVICE WITH GENERAL PURPOSE INPUT OUTPUT EXPANDER AND SIGNAL DETECTION METHOD

(71) Applicant: WEN-CHONG TU, Shenzhen City (CN)

(72) Inventor: WEN-CHONG TU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/450,498

(22) Filed: Apr. 19, 2012

(30) Foreign Application Priority Data
Dec. 9, 2011 (CN) 201110409092.5

(51) Int. Cl. G06F 13/36

(52) U.S. Cl. 710/306

(57) ABSTRACT

An electronic device includes a general purpose input output (GPIO) expander and a baseboard management controller (BMC). The GPIO expander includes a number of GPIO interfaces and a gathering interface connected to the GPIO interfaces. The BMC includes a public interface and a scanning interface connected to the gathering interface. Each element is connected to the public interface and a different one of the GPIO interfaces. The BMC periodically detects whether there is a signal input from the public interface, scans the GPIO interfaces when there is a signal input from the public interface to determine a GPIO interface with a logic high level, an element connected to the GPIO interface, and a signal input from the element, and records an event including the GPIO interface, the element connected to the GPIO interface, and the signal, and stores the event.

### BACKGROUND

1. Technical Field

The present disclosure relates to electronic devices and, more particularly, to an electronic device with a general purpose input output expander and a signal detection method.

2. Description of Related Art

An electronic device, such as a server, includes a baseboard management controller (BMC), a number of central processing units (CPU), and a number of memory units. All the CPUs and the memory units should be connected to general purpose input output (GPIO) interfaces of the BMC in order to allow the BMC to be capable of recording events happening on each CPU or memory unit when receiving a high-speed signal from the CPU or memory unit, wherein the high-speed signal includes information indicating what happened to the CPU or memory unit. For example, the BMC records an event that a CPU has overheated when receiving a thermal trip signal from the CPU which indicates the temperature of the CPU is high. However, the number of the GPIO interfaces of the BMC is limited for allowing more CPUs and memory units to be connected to the GPIO interfaces of the BMC.

### BRIEF DESCRIPTION OF THE DRAWINGS

The components in the drawings are not necessarily drawn to scale, the emphasis instead being placed upon clearly illustrating the principles of the present disclose. Moreover, in the drawings, like reference numerals designate corresponding parts throughout the several views.

FIG. 1 is a schematic view showing connections between external components of an electronic device with a GPIO expander, in accordance with an exemplary embodiment.

FIG. 2 is a module diagram of a BMC of the electronic device of FIG. 1.

FIG. 3 is a flowchart of a signal detection method in accordance with an exemplary embodiment.

### DETAILED DESCRIPTION

The disclosure is illustrated by way of example and not by way of limitation. It should be noted that references to “an” or “one” embodiment in this disclosure are not necessarily to the same embodiment, and such references mean at least one.

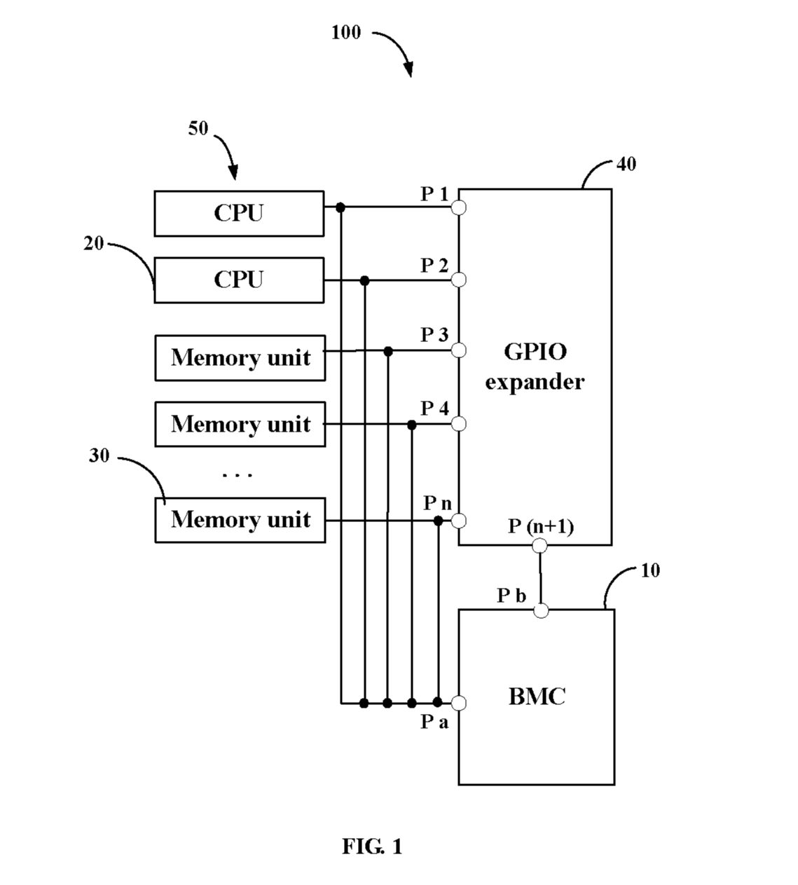

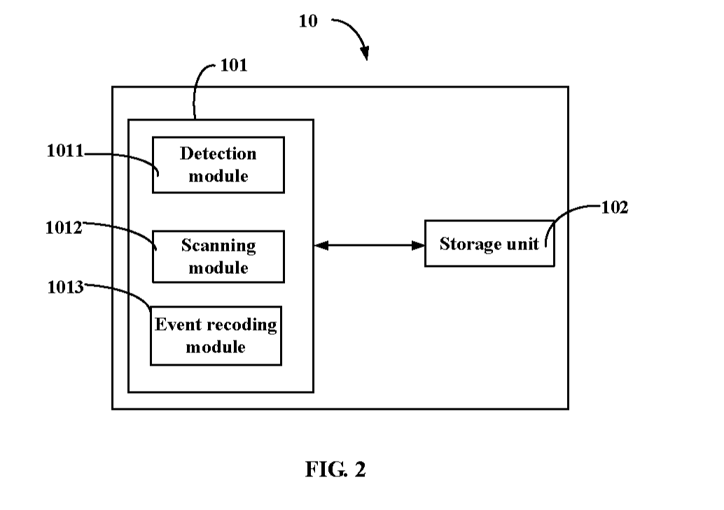

FIGS. 1 and 2 show an electronic device 100 including a baseboard management controller (BMC) 10, a number of elements 50, such as central processing units (CPUs) 20 and memory units 30, and a general purpose input output (GPIO) expander 40. The BMC 10 includes a public interface Pa and a scanning interface Pb. The GPIO expander 40 includes a number of GPIO interfaces P1-Pn and a gathering interface P(n+1), wherein the gathering interface P(n+1) is connected to all the interfaces P1-Pn. In this embodiment, for convenient description, the electronic device 100 including two CPUs 20 and a number of memory units 30 is taken as an example. The two CPUs 20 and the number of memory units 30 are respectively connected to different GPIO interfaces P1-Pn of the GPIO expander 40, and connected together to the public interface Pa. The GPIO expander 40 is connected to the scanning interface Pb of the BMC 10 through the gathering interface P(n+1). The BMC 10 may be AST2150, and the GPIO expander 40 may be PCA 9535 expander or PCA 9555 expander, for example.

The BMC 10 includes a processing unit 101 and a storage unit 102. The processing unit 101 includes a detection module 1011, a scanning module 1012, and an event recording module 1013. The detection module 1011 is controlled by the processing unit 101 to periodically detect whether there is a signal input in the public interface Pa of the BMC 10. In this embodiment, signal input from a CPU 20 or a memory unit 30 to the interface Pa is in a logic high level, which includes information indicating what happened to the CPU 20 or the memory unit 30. Thus, if no signal input from the CPUs 20 and the memory units 30, the interface Pa is in a logic low level, and any signal input from the CPUs 20 or the memory units 30 will cause the interface Pa to be in a logic high level.

The scanning module 1012 scans the interfaces P1-Pn through the interface Pb and P(n+1) when there is a high level from the public interface Pa, to determine a GPIO interface with the logic high level, the element 50 (such as a CPU 20 or a memory unit 30) which is connected to the GPIO interface with the logic high level, and the signal from the element 50. The signal may be received by the BMC 10 through the interface Pa or the interface P(n+1) and Pb. The event recording module 1013 records an event including the interface, the element connected to the interface, and the signal, and stores the event in the storage unit 102.

From the above description, when one of the elements 50 needs to be shut down to avoid being damaged because of some occurrence such as a high temperature, an event including an element 50 which transmits a signal to the BMC 10, the interface of the GPIO expander 20 connected to the element 50, and the signal is stored in the storage unit 102. Thereby, the recorded event provides an easy method for a user to find out what caused the element 50 to shut down. In this embodiment, the element 50 is controlled to delay a certain time, such as 2 seconds to shut down to allow the event recording module 1013 to have enough time to record the corresponding event.

Because the CPUs 20 and the memory units 30 are respectively connected to different interfaces P1-Pn of the GPIO expander 40, interfaces of the BMC 10 are saved for other use.

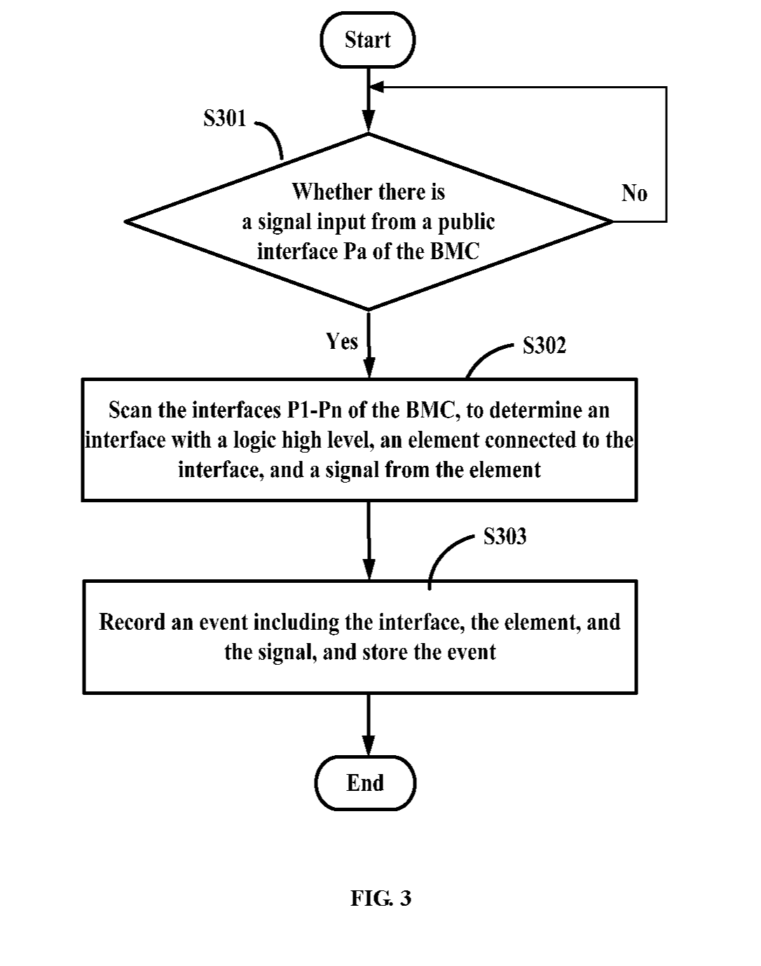

FIG. 3 discloses a flowchart of a signal detection method. The signal detection method includes the below procedures.

In step S301, the detection module 1011 is controlled by the processing unit 101 to periodically detect whether there is a signal input from the public interface Pa of the BMC 10. If there is a signal input from the public interface Pa, the procedure goes to step S302, otherwise, the procedure repeats the step S301.

In step S302, the scanning module 1012 scans the interfaces P1-Pn, to determine an GPIO interface with the logic high level, the element 50 which is connected to the GPIO interface with the logic high level, and the signal from the element 50.

In step S303, the event recording module 1013 records an event including the interface, the element 50 connected to the interface, and the signal, and stores the event in the storage unit 102.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a general purpose input output (GPIO) expander, comprising a plurality of GPIO interfaces and a gathering interface connected to the plurality of GPIO interfaces;
at least one element; and
a baseboard management controller (BMC), comprising a public interface and a scanning interface connected to the gathering interface, each element being connected to the public interface and a different one of the GPIO interfaces of the GPIO expander, the BMC further comprising:
a detection module for periodically detecting whether there is a signal input from the public interface, wherein the signal is transmitted from an element and comprises information indicating what happened about the element;
a scanning module for scanning the plurality of GPIO interfaces through the scanning interface when there is a signal input from the public interface, to determine a GPIO interface with a logic high level, an element connected to the GPIO interface with the logic high level, and a signal input from the element; and
an event recording module for recording an event comprising the GPIO interface with the logic high level, the element connected to the GPIO interface with the logic high level, and the signal from the element, and for storing the event.

2. The electronic device as described in claim 1, wherein the element is a central processing unit (CPU) or a memory unit, and the electronic device comprises at least one CPU and at least one memory unit.

3. The electronic device as described in claim 1, wherein the BMC is an AST2150, and the GPIO expander is a PCA 9535 expander or a PCA 9555 expander.

4. An event recording method for recording event in an electronic device, the electronic device comprising at least one central processing unit (CPU), at least one memory unit, a general purpose input output (GPIO) expander, and a baseboard management controller (BMC), the GPIO expander comprising a plurality of GPIO interfaces and a gathering interface connected to the plurality of GPIO interfaces, the BMC comprising a public interface and a scanning interface connected to the gathering interface, the at least one CPU and the at least one memory unit being connected to the public interface and different GPIO interfaces of the GPIO expander, the event recording method comprising:
detecting whether there is a signal input from the public interface, wherein the signal is transmitted from one of the at least one CPU and at least one memory unit and comprises information indicating what happened about the one of the at least one CPU and at least one memory;
scanning the plurality of GPIO interfaces through the scanning interface when there is a signal input from the public interface, to determine a GPIO interface with a logic high level, a CPU or a memory unit connected to the GPIO interface with the logic high level, and a signal input from the at least one CPU or memory unit; and
recording an event comprising the GPIO interface with the logic high level, the CPU or memory unit connected to the GPIO interface with the logic high level, and the signal from the CPU or memory unit, and storing the event.
